(19) United States
(12) Patent Application Publication
(10) Pub. No.: US 2025/0235879 A1
(43) Pub. Date: Jul. 24, 2025

(54) CENTRIFUGE WITH TRANSFORMABLE MECHANISM

(71) Applicant: CHIN HUNG WANG, Taipei City (TW)

(72) Inventor: CHIN HUNG WANG, Taipei City (TW)

(21) Appl. No.: 19/033,355

(22) Filed: Jan. 21, 2025

(30) Foreign Application Priority Data
Jan. 23, 2024 (TW) 113102550

(51) Int. Cl. B04B 5/04

(52) U.S. Cl. CPC B04B 5/0421

(57) ABSTRACT

The present invention provides a centrifuge including a rotor and multiple mounts. Each mount includes multiple transform units, and each transform unit is pivotally and reciprocatively connected to the mount and provides an accommodation means or a carrying means for accommodating or carrying a centrifuge test tube, such that during rotation of the rotor, each transform unit, in response to a rotation speed, adjusts a relationship thereof with the mount by pivoting and reciprocating, enabling the multiple centrifuge test tubes supported on the multiple mounts to rotate at a consistent rotation radius.

### TECHNICAL FIELD

The present invention relates to an improved structure of a centrifuge, and particularly relates to a centrifuge for use with centrifuge test tubes in multi-position rows.

### BACKGROUND

In chemical and biological examinations and experiments, centrifuges are commonly used devices, which mainly use sedimentation and centrifugal motion to separate substances in a target sample, e.g., to separate specific cellular substances from a biological blood sample. In actual applications, the placement of centrifuge test tubes in the centrifuge is usually strictly regulated to ensure that the centrifuge test tubes can move along a correct trajectory, thereby preventing the centrifuge from producing unnecessary vibrations to adversely affect test results.

FIG. 1 shows a centrifuge (1) configured with multi-position rows, the centrifuge being driven by a control module (10). In particular, the control module (10) is electrically connected to a motor (not shown), and the motor is mechanically connected to a rotor (11) of the centrifuge (1) via a rotating shaft (not shown). An operation interface (12) is electrically connected to the control module (10), and is configured such that a user can input instructions (e.g., parameters such as rotational speed and time) to the control module (10) to drive the motor.

FIG. 2 shows an existing multi-position-row configuration, where each section has a row consisting of eight positions, that is, eight centrifuge test tubes can be placed at each section. Since existing test tube mounts of the rotor (11) are all fixed mechanisms, distances between the positions (21, 22, 23, 24, 25, 26, 27, 28) of the centrifuge test tubes and the rotation center (C) of the rotor (11) are not all the same. As shown, there is a significant difference between the distance from a position close to the middle of the multi-position row, e.g., the position (25), to the rotation center (C) and the distance from a position close to either of the two ends of the multi-position row, e.g., the position (28), to the rotation center (C). In particular, the position (25) has a rotation radius R5 and the position (28) has a rotation radius R8, and R5 is less than R8. Accordingly, during a centrifugation operation, the centrifuge test tube at the position (28) is subjected to a greater centrifugal force than the centrifuge test tube at the position (25), which may result in different degrees of separation in the two test tubes. As the number of positions in the multi-position row increases, such differences in radius and the degree of separation become more significant.

In addition, existing multi-position-row mounts are mostly fixed, that is, the centrifuge test tubes are placed at each position (21 to 28) in a specific orientation. If the centrifuge test tubes are placed in an upright manner, then test tubes close to the center of the multi-position row and test tubes at the two ends of the multi-position row will be subjected to forces from different directions during a centrifugation process, which is not conducive to obtaining consistent separation results.

Therefore, it is still necessary to improve existing centrifuges configured with multi-position rows.

### SUMMARY

The present invention aims to provide a centrifuge, comprising: a rotor having a rotation center; and multiple mounts connected to the rotor and arranged along a periphery of the rotor, each mount being configured to support multiple centrifuge test tubes; wherein each mount comprises multiple transform units, and each transform unit is pivotally and reciprocatively connected to the mount and provides an accommodation means or a carrying means for accommodating or carrying a centrifuge test tube, such that during rotation of the rotor, each transform unit, in response to a rotation speed, adjusts a relationship thereof with the mount by pivoting and reciprocating, enabling the multiple centrifuge test tubes loaded on the multiple mounts to rotate at a consistent rotation radius.

In a specific embodiment, the mount has a center portion and two ends, the multiple transform units comprised in the mount are arranged between the two ends of the mount, and the multiple transform units are connected to the mount in a parallel connection configuration.

In a specific embodiment, the mount has a top portion and a bottom portion, and the multiple transform units are confined between the top portion and the bottom portion of the mount to pivot and reciprocate.

In a specific embodiment, the mount has multiple tracks, and each of the multiple transform units comprised in the mount is slidably connected to the mount through a corresponding track, so that each transform unit is reciprocatable relative to the mount along the corresponding track.

In a specific embodiment, each of the multiple tracks has an inner end and an outer end, the multiple tracks have different path lengths, and the path lengths of tracks close to the two ends of the mount are shorter than the path lengths of tracks close to the center portion of the mount.

In a specific embodiment, each transform unit has a pivot, and each transform unit is pivotally connected to the mount via the pivot, so that each transform unit is pivotable relative to the mount according to the pivot, wherein the pivot is parallel to a direction of a rotating shaft connected to the rotor.

In a specific embodiment, the mount has multiple reset units, and each reset unit provides, to a corresponding transform unit, a reset force pointing approximately to the rotation center of the rotor, so that each transform unit is located at an inner end of a corresponding track when the rotor is stationary.

In a specific embodiment, all the outer ends of the multiple tracks of the multiple mounts approximately match a circular trajectory.

In a specific embodiment, a portion of each transform unit is located between the top portion and the bottom portion of the mount and unexposed, and the other portion of each transform unit is exposed outside of the mount and has a hook for suspension of a centrifuge test tube.

In a specific embodiment, each mount comprises eight or twelve transform units.

### BRIEF DESCRIPTION OF DRAWINGS

The present disclosure can be further understood by referring to the following drawings and description. Non-limiting and non-exhaustive examples will be described with reference to the following drawings. The components in the drawings are not necessarily drawn in actual size. The focus is on illustrating the structure and principle.

FIG. 1 shows a centrifuge configured with multi-position rows.

FIG. 2 shows the configuration of an existing centrifuge configured with fixed multi-position rows and a difference in rotation radius.

FIG. 3 shows a perspective view of a centrifuge with a transformable mechanism according to the present invention.

FIG. 4 shows a cross-sectional structure along line AA.

FIG. 5A shows a first embodiment of a reset unit.

FIG. 5B shows a second embodiment of the reset unit.

FIG. 5C shows a third embodiment of the reset unit.

FIG. 6A shows a top view of the centrifuge (in a reset state) according to the present invention.

FIG. 6B shows a top view of the centrifuge (in a transformed state) according to the present invention.

FIG. 7A shows a perspective view of a variation example of a transform unit.

FIG. 7B shows a front view of the variation example of the transform unit.

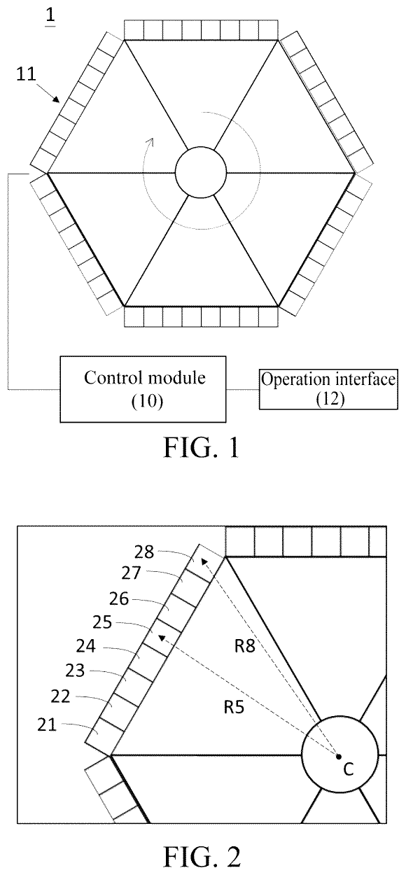

### DESCRIPTION OF EMBODIMENTS

The present invention will now be described more fully hereinafter with reference to the drawings, which show, by way of illustration, specific exemplary embodiments. The subject matter may, however, be embodied in a variety of different forms and, therefore, the covered or claimed subject matter is intended to be construed as not being limited to any exemplary embodiments set forth in the description; exemplary embodiments are provided merely to be illustrative. Likewise, the present invention aims to provide a reasonably broad scope for the claimed or covered subject matter. In addition, the drawings and examples in the present invention are generally not drawn to scale and are not intended to correspond to actual relative dimensions.

For purposes of consistency and ease of understanding, identical features are designated by numerals in the illustrative drawings (although not so designated in some examples). However, the features in different implementations may differ in other ways and thus should not be narrowly limited to the features shown in the drawings. The terms “first” and “second” in the description of the present invention and in the drawings above are used to distinguish different objects and are not used to describe a particular sequence.

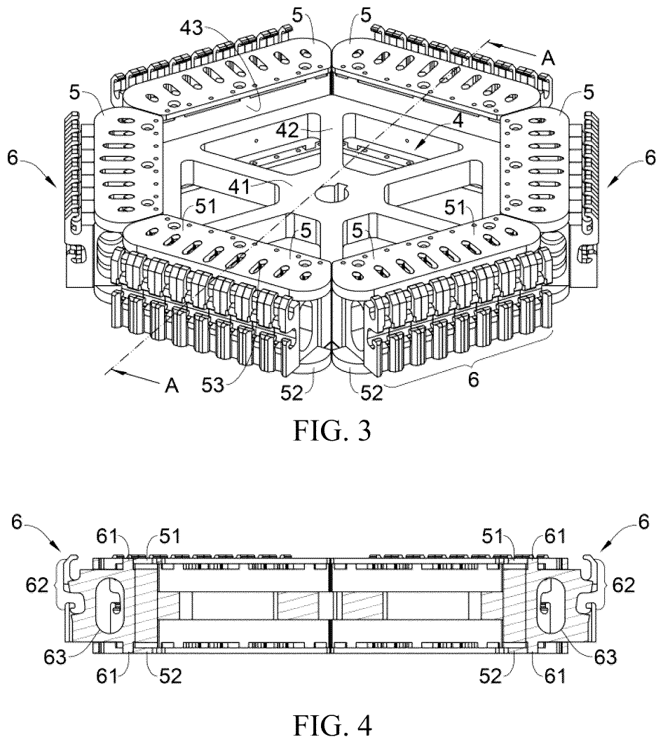

FIG. 3 shows a perspective view of a centrifuge with a transformable mechanism according to the present invention. FIG. 4 shows a cross-sectional structure along line AA. Portions such as a rotating shaft, a motor, a control module, a housing and an operation interface included in the centrifuge are not improved portions of the present invention, so they are omitted and not shown, but those having ordinary skill in the field to which the present invention pertains would be able to understand this content.

The centrifuge of the present invention mainly includes a rotor (4) and multiple mounts (5). The rotor (4) in an illustrated embodiment basically consists of a center disk (41), multiple spokes (42) and a frame (43), where the length of the spoke (42) and the shape of the frame (43) are appropriately configured so that the rotor (4) is structured as a regular hexagon, but the present invention is not limited thereto. A hole for coupling a power shaft (omitted and not shown) is formed on the center disk (41) of the rotor (4). As shown, six mounts (5) are connected at the periphery of the rotor (4) and are symmetrically arranged relative to the center of the rotor (4). Each mount (5) is configured to support multiple centrifuge test tubes and may be designed to have an eight-position row or a twelve-position row as required. Each mount (5) has a center portion and two ends, and one end of a mount (5) abuts only one end of another mount (5). The mount (5) of the present invention has a transformable mechanism, which acts during a centrifugation operation, and the details will be described below.

The mount (5) includes multiple transform units (6), and each transform unit (6) is pivotally and reciprocatively connected to the mount (5). As can be seen from FIG. 4, a portion of the transform unit (6) is located in the mount (5) and unexposed, and the other portion of the transform unit (6) is exposed outside of the mount (5). The transform unit (6) has a thin structure, but has a certain structural strength. The transform unit (6) may be an integrally formed sheet material. An inner portion of the transform unit (6) has a pivot (61) and an outer portion thereof has at least one hook (62). The transform unit (6) further has a hollow portion (63) formed for the purpose of lightweight design.

The transform units (6) are connected to the mount (5) in a parallel connection configuration. The mount (5) has a top portion (51) and a bottom portion (52) which extend outward from the frame (43), and the multiple transform units (6) included in the mount (5) are confined between the top portion (51) and the bottom portion (52), exposing the hook (62) of each transform unit (6). In particular, a downward facing surface of the top portion (51) and an upward facing surface of the bottom portion (52) are pressed against an upward facing surface and a downward facing surface of the transform unit (6), respectively, so as to restrict a vertical movement direction of the transform unit (6).

As shown in FIG. 3, the top portion (51) of the mount (5) defines multiple tracks (53) between the two ends, and the path lengths of tracks (53) close to the two ends of the mount (5) are shorter than the path lengths of tracks (53) close to the center portion of the mount (5). The inner ends of the tracks (53) are located on a straight line, while the outer ends are approximately located on a circular trajectory. Although not shown in the figure, a track configuration corresponding to that of the top portion (51) is also formed at the bottom portion (52). Each transform unit (6) is connected to a corresponding track (53) of the mount (5) via the pivot (61) so that the transform unit (6) reciprocates relative to the mount (5) along the track (53), where the pivot (61) is approximately in the same direction as the rotating shaft. Of course, according to different track path lengths, reciprocating ranges that can be achieved by the transform units (6) are also different. In addition, since the inner and outer ends of the track (53) each have a circular arc structure, the transform unit (6) can pivot at any position on the track (53) via the pivot (61) that has a cylindrical shape. In other words, each transform unit (6) is reciprocatable along the track (53), and can also pivot freely. The relative relationship between the track (53) and the pivot (61) in the illustrated embodiment may be observed from a top view or a bottom view, but in other embodiments, the track (53) may also be located entirely inside the mount (5) and cannot be observed from the outside.

The hook of the transform unit (6) is shown in the figure. A centrifuge test tube (not shown) may be provided with a corresponding mechanism so that an operator or a robotic arm can suspend the centrifuge test tube on the hook (62). In this case, the centrifuge test tube is less constrained than the transform unit (6). Alternatively, the hook (62) of the transform unit (6) may be replaced by an accommodation means or other carrying means. For example, the transform unit (6) may be configured with a slot for accommodating the centrifuge test tube. In this case, the centrifuge test tube is constrained and does not easily move. In summary, the transform units (6) included in the mount (5), while restricted in the vertical direction, are not restricted in radial reciprocation and horizontal pivoting and oscillation.

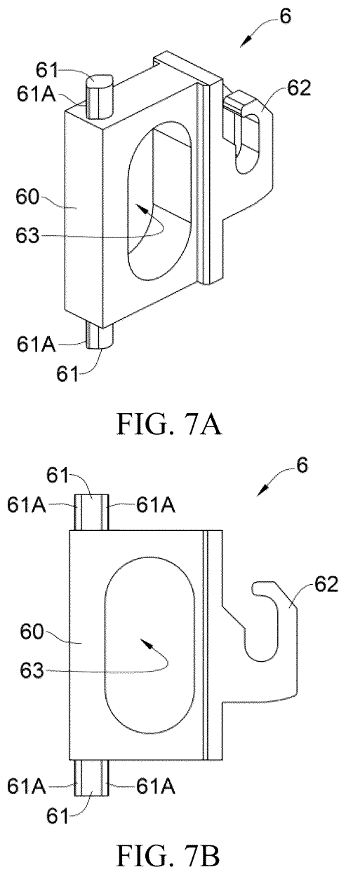

FIG. 7A and FIG. 7B show a variation example of the transform unit (6), which has a main body (60), a pair of pivots (61), a hook (62), and a hollow portion (63). The main body (60) is basically a hexahedral structure having a height, a width, and a length. The pivots (61) protrude from an upper surface and a lower surface of the main body (60), respectively, and each pivot (61) is approximately cylindrical and has a pair of ribs (61A). The pivoting range of the transform unit (6) may be limited due to the relationship between the ribs (61A) and the width of the track (53). The hook (62) is located on a side surface of the main body (60) and is essentially an upward extending structure, but the present invention is not limited thereto. In general, the centrifuge test tubes in a multi-position row can be suspended from the hooks (62) by a known means, related details of which are not described herein.

In a preferred embodiment of the present invention, the mount (5) further has multiple reset units, and each reset unit is configured to apply an appropriate reset force (a pulling force or a pushing force) to the transform unit (6), such that all the transform units (6) retreat to the inner side of the mount (5) in a stationary state or during low-speed rotation. The amount of the reset force is properly designed so that the transform unit (6) can overcome the reset force during high-speed rotation and extend to the outer side of the mount (5).

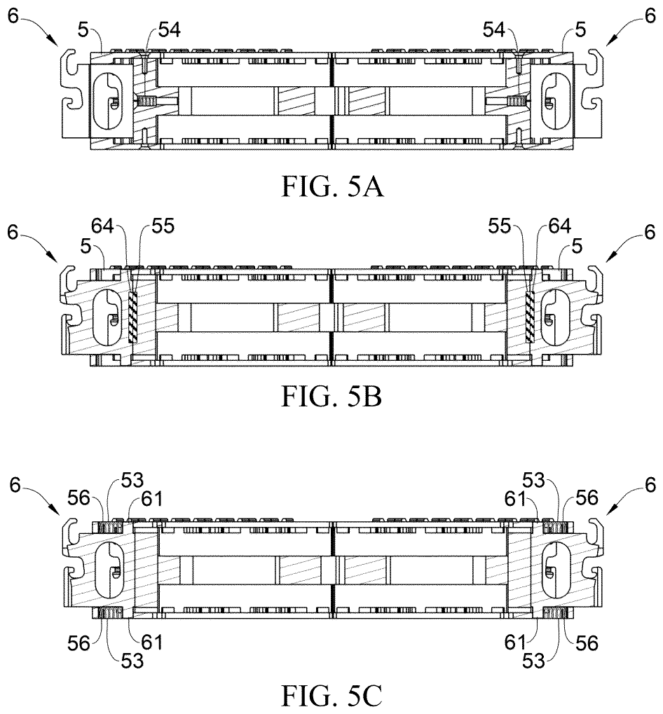

FIG. 5A shows a first embodiment of the reset unit. The reset unit is a spring (54) or other elastic means inserted into the inner side of the mount (5). In this schematic diagram, one end of the spring (54) is inserted in the mount (5) and the other end is connected to the inner side of the transform unit (6). Alternatively, one end of the spring (54) is inserted in the transform unit (6), while the other end is connected to the inner side of the mount (5). In either configuration, the spring (54) provides a pulling force to force the transform unit (6) to move toward the inner side of the mount (5). An elastic coefficient of the spring (54) can be appropriately selected so that a centrifugal force of the transform unit (6) can be greater than the pulling force of the spring (54) during high-speed rotation.

FIG. 5B shows a second embodiment of the reset unit. The reset unit includes one or more magnets (55) arranged on the inner side of the mount (5) and a magnetic portion (64) arranged on the inner side of the transform unit (6). The magnetic portion (64) may be a magnetic metal or a magnet, and the transform unit (6) can be attracted by the magnets (55) on the inner side of the mount (5) to force the transform unit (6) to move toward the inner side of the mount (5). A material magnetic coefficient of the magnets (55) can be appropriately selected so that the centrifugal force of the transform unit (6) can be greater than an attraction force generated by the magnetic field during high-speed rotation.

FIG. 5C shows a third embodiment of the reset unit. The reset unit is a spring (56) or other elastic means disposed in the track (53). In this schematic diagram, one end of the spring (56) abuts against the pivot (61) of the transform unit (6), and the other end abuts against the outer end of the track (53). The spring (56) provides a compressive force to the pivot (61) to force the transform unit (6) to move toward the inner side of the mount (5). Similarly, an elastic coefficient of the spring (56) can be appropriately selected so that the centrifugal force of the transform unit (6) can be greater than the compressive force of the spring (56) during high-speed rotation.

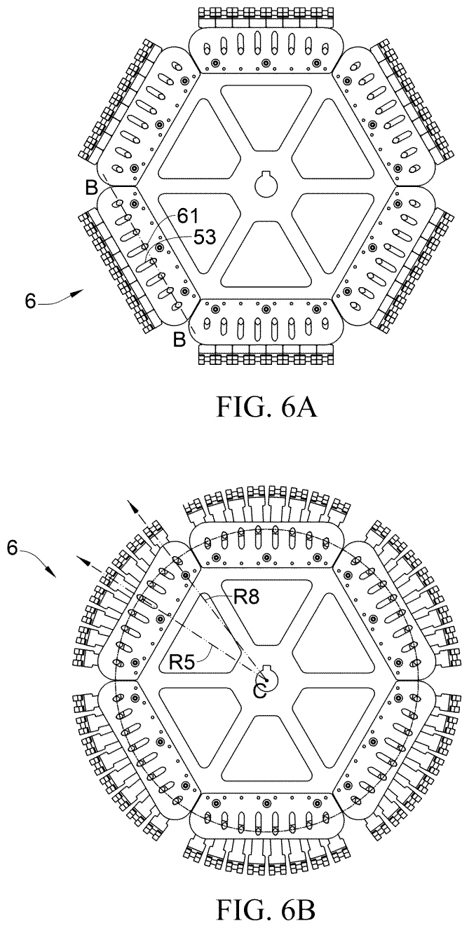

FIG. 6A shows a reset state of the centrifuge according to the present invention. The reset force provided by the reset unit, whether it is a pulling force, a compressive force or a magnetic force, can force the transform unit (6) to move toward the inner side of the mount (5), and the pivot (61) of the transform unit (6) is located at the inner end of the track (53). Since the inner ends of the tracks (53) on each mount (5) are located on a reference line (BB) parallel to a side of the hexagon, the transform units (6) in the reset state are arranged in a flush distribution.

In other possible embodiments, the reset units may be omitted. The mount (5) can be appropriately modified to be inclined such that the outer end of the track (53) is higher than the inner end. Thus, when the rotor (4) is stationary or rotating at a low speed, the transform unit (6) can fall to the inner end of the track (53) due to its own weight.

FIG. 6B shows a transformed state of the centrifuge according to the present invention. During operation of the centrifuge, the rotor (4) spins each transform unit (6) at a specific rotational speed so that the transform units (6) overcomes the reset force and move toward the outer ends of the tracks (53). Since the path lengths of the tracks (53) are not consistent, and the path lengths of tracks (53) close to the center portion of the mount (5) are greater than the path lengths of tracks (53) close to the two ends of the mount (5), the outer ends of the tracks (53) approximately match a circular trajectory (as shown by the dashed line). Under the condition of constant-speed motion, the transform units (6) extend outward relative to the mount (5) and exhibit different degrees of pivoting. The transform units (6) originally close to each other become separated from each other, and transform units (6) close to the center portion of the mount (5) have smaller pivoting ranges, while transform units (6) close to the two ends of the mount (5) have larger pivoting ranges. All the transform units (6) are distributed in a rotationally symmetrical manner relative to the rotation center (C). In other words, a radius (R5) from a transform unit (6) close to the center of the mount (5) to the rotation center (C) is essentially the same as a radius (R8) from a transform unit (6) at either of the two ends of the mount (5) to the rotation center (C). Hence, in the transformed state (during rotation), the motion paths of the centrifuge test tubes carried by all the transform units (6) are basically the same. Once the rotor (4) slows down from rotating at a constant speed to a stationary state, the control of the transform units (6) will gradually be dominated by the reset force, so that the transform units retreat to the inside of the mount (5), and eventually return to the state as shown in FIG. 6A.

In summary, the centrifuge with a transformable mechanism according to the present invention is switched between the reset state and the transformed state according to the rotational speed of the motor, where in the reset state, an operator end can easily loads or unloads the centrifuge test tubes in multi-position rows, and in the transformed state, all the centrifuge test tubes can exhibit rotational symmetry to ensure that separation results of chemical or biological samples are fairly consistent.

It should be understood that each particular embodiment of the present invention is for illustrative purpose only, and various changes can be made without departing from the scope of the claims and the spirit of the present invention, and should still fall within the scope of the present invention. Therefore, each particular embodiment described in the description is not intended to limit the present invention, and the actual scope and spirit of the present invention are disclosed in the following claims.

### LIST OF REFERENCE NUMERALS

1 Centrifuge
10 Control module
11 Rotor
12 Operation interface
21-28 Positions of centrifuge test tubes
4 Rotor
41 Center disk
42 Spoke
43 Frame
5 Mount
51 Top portion
52 Bottom portion
53 Track
54 Spring
55 Magnet
56 Spring
6 Transform unit
60 Main body
61 Pivot
61A Rib
62 Hook
63 Hollow portion
64 Magnetic portion
R5 Radius
R8 Radius
C Rotation center

1. A centrifuge, comprising:
a rotor having a rotation center; and
multiple mounts, connected to the rotor and arranged along a periphery of the rotor, each mount being configured to support multiple centrifuge test tubes;
wherein each mount comprises multiple transform units, and each transform unit is pivotally and reciprocatively connected to the mount and provides an accommodation means or a carrying means for accommodating or carrying a centrifuge test tube, such that during rotation of the rotor, each transform unit, in response to a rotation speed, adjusts a relationship thereof with the mount by pivoting and reciprocating, enabling the multiple centrifuge test tubes loaded on the multiple mounts to rotate at a consistent rotation radius.

2. The centrifuge according to claim 1, wherein the mount has a center portion and two ends, the multiple transform units comprised in the mount are arranged between the two ends of the mount, and the multiple transform units are connected to the mount in a parallel connection configuration.

3. The centrifuge according to claim 1, wherein the mount has a top portion and a bottom portion, and the multiple transform units are confined between the top portion and the bottom portion of the mount to pivot and reciprocate.

4. The centrifuge according to claim 1, wherein the mount has multiple tracks, and each of the multiple transform units comprised in the mount is slidably connected to the mount through a corresponding track, so that each transform unit is reciprocatable relative to the mount along the corresponding track.

5. The centrifuge according to claim 4, wherein each of the multiple tracks has an inner end and an outer end, the multiple tracks have different path lengths, and the path lengths of tracks close to the two ends of the mount are shorter than the path lengths of tracks close to the center portion of the mount.

6. The centrifuge according to claim 1, wherein each transform unit has a pivot, and each transform unit is pivotally connected to the mount via the pivot, so that each transform unit is pivotable relative to the mount according to the pivot, wherein the pivot is parallel to a direction of a rotating shaft connected to the rotor.

7. The centrifuge according to claim 4, wherein the mount has multiple reset units, and each reset unit provides a reset force to a corresponding transform unit, so that each transform unit is located at an inner end of a corresponding track when the rotor is stationary.

8. The centrifuge according to claim 5, wherein all the outer ends of the multiple tracks of the multiple mounts approximately match a circular trajectory.

9. The centrifuge according to claim 3, wherein a portion of each transform unit is located between the top portion and the bottom portion of the mount and thus unexposed, and the other portion of each transform unit is exposed outside of the mount and has a hook for suspension of a centrifuge test tube.

10. The centrifuge according to claim 1, wherein each mount comprises eight or twelve transform units.
